(19) United States
(12) Patent Application Publication
(10) Pub. No.: US 2006/0279644 A1
(43) Pub. Date: Dec. 14, 2006

(54) Image processing apparatus and image processing method

(75) Inventor: Kozo Toda, Kokubunji-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/448,060

(22) Filed: Jun. 6, 2006

(30) Foreign Application Priority Data
Jun. 10, 2005 (JP) 2005-170224

(51) Int. Cl. H04N 5/76

(52) U.S. Cl. 348/231.6

(57) ABSTRACT

When charge collection processing for a predetermined image processing request via removable memory is performed in an image processing apparatus, from which the removable memory is detachable via a removable memory interface, a central processing unit causes the removable memory interface to shift to a disconnected state based on a completion state of the predetermined image processing request by a scanner, printer, or the like via the removable memory.

### BACKGROUND OF THE INVENTION

1. Field of the Invention

The present invention relates to an image processing apparatus equipped with a charging processing function, and in particular, relates to an image processing apparatus that can execute a predetermined image processing request with removable memory connected thereto via an interface, an image processing method, a storage medium in which a program that can be read by a computer is stored, and a program.

2. Description of the Related Art

An MFP (multifunction peripheral) apparatus that carries out such functions as copying, printing, and scanning in a unit has been widely known. Such apparatus is equipped with a reader for documents and a recorder for image data and implements the functions of copying, printing, and scanning by controlling each section of the apparatus.

Also, a service of, for example, copying is generally known, which is provided by installing such MFP apparatus in a public place such as a shop, equipping the apparatus with a charging apparatus and collecting charges from general users. An example of such a charging service is discussed in Japanese Patent Application Laid-Open No. 2004-062706.

Recently, on the other hand, small-sized removable memory equipped with a standard interface such as USB (universal serial bus) has been in widespread use as a recording medium for electronic data. Such removable memory were originally used to preserve data edited on a personal computer or to deliver data to another personal computer by carrying such removable memory in which data is preserved.

In such USB connection type removable memory, after an operator connects removable memory to a USB interface of a personal computer, the personal computer recognizes the connection and activates the removable memory to enable reading data from the memory and writing data to the memory.

When removing the removable memory from the personal computer, on the other hand, the operator can remove at any time the removable memory from the USB interface of the personal computer.

However, if USB connection is cut off when the personal computer is reading data from the removable memory or writing data to the removable memory, damage to memory data in the removable memory can occur.

Thus, in the operating system (OS) of a personal computer, it is recommended that when removing an interface-connected storage device such as removable memory, the operator should perform an operation of disconnecting an interface in the operating system.

That is, when the operator disconnects a USB interface connected removable memory in the operating system of a personal computer, the personal computer performs the procedures for terminating data writing and data reading with respect to the removable memory, deactivates the removable memory, and notifies the operator that the removable memory is removable while displaying a message.

This enables the operator to safely remove the removable memory from the personal computer.

With respect to the above-described MFP apparatus equipped with a charging function, new services providing, in addition to the conventionally known copy service, print and scan services to the general public while collecting charges can be considered in the future.

If such services are provided, a user may bring portable removable memory for carrying print image data or storing scan image data and carry out the print or scan function while connecting the portable removable memory to an interface of the MFP apparatus equipped with a charging function.

In such cases, the user first connects removable memory to the interface of the MFP apparatus equipped with a charging function, performs print or scan operations, and then removes the removable memory from the interface.

However, as described in the procedure for connecting and removing removable memory in a personal computer, particularly when the removable memory is removed, it may be possible to safely remove the removable memory only after disconnecting an interface and deactivating the removable memory to prevent damage of memory data.

Therefore, even when mounting a connection interface for removable memory on an MFP apparatus with a charging function to provide a print or scan function, consideration for safely removing removable memory is required. Particularly with respect to an MFP apparatus with a charging function for use by the general public, removable memory must be safely removable without requiring specific operations, because some users may be unaccustomed to handling removable memory.

### SUMMARY OF THE INVENTION

The present invention is directed to an image processing apparatus, an image processing method, and a computer-readable medium having stored thereon a computer program having program code having computer-executable instructions for causing a computer to execute the image processing method, which can prevent or reduce situations in which removable memory is detached in such improper timing as to cause problems for an image processing request via removable memory. Also, the present invention is directed to an image processing apparatus, an image processing method, and a computer-readable medium having stored thereon a computer program comprising program code having computer-executable instructions for causing a computer to execute the image processing method, which can allow an operator to safely remove removable memory after an operation without being aware of the procedure for removing the removable memory, thus preventing damage of data in the removable memory and memory destruction and, also, increasing user convenience.

In an aspect of the present invention, an image processing apparatus includes an interface unit adapted to connect removable memory thereto, an image processing execution unit adapted to execute image processing via the removable memory, a charging unit adapted to perform charge collection processing for execution of the image processing, a determination unit adapted to determine whether charge collection processing by the charging unit is possible or not, and a control unit adapted to, responsive to the determination unit determining that the charge collection processing is possible and when execution of the image processing for which collection processing can be performed by the charging unit is completed, cause the charging unit to perform collection processing for execution of the image processing and cause the interface unit to shift to a disconnected state so as to make the removable memory removable.

In another aspect of the present invention, an image processing method for an image processing apparatus including an interface unit adapted to connect removable memory thereto includes an image processing execution step of executing image processing via the removable memory, a charging step of performing charge collection processing for execution of the image processing, a determination step of determining whether charge collection processing in the charging step is possible or not and a controlling step of, when it is determined in the determination step that the charge collection processing is possible and execution of the image processing for which collection processing can be performed in the charging step is completed, performing the charging step of performing collection processing for execution of the image processing and causing the interface unit to shift to a disconnected state so as to make the removable memory removable.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of an image processing apparatus according to a first embodiment of the present invention.

FIG. 2 is a timing chart illustrating a configuration and operation of interface signals shown in FIG. 1.

FIG. 3 is a table illustrating processing indicated by a combination of processing completion data.

FIG. 4 is a flowchart showing an example of a first data processing procedure in the image processing apparatus according to the embodiment.

FIG. 5 is a flowchart showing an example of a second data processing procedure in the image processing apparatus according to the embodiment.

FIG. 6 is a flowchart showing an example of a third data processing procedure in the image processing apparatus according to the embodiment.

FIG. 7 is a flowchart showing an example of a fourth data processing procedure in the image processing apparatus according to the embodiment.

FIG. 8 is a flowchart showing an example of a fifth data processing procedure in the image processing apparatus according to the embodiment.

FIG. 9 is a flowchart showing an example of a sixth data processing procedure in the image processing apparatus according to the embodiment.

FIG. 10 is a diagram illustrating a memory map of a storage medium in which various data processing programs that can be read by the image processing apparatus according to the embodiment are stored.

### DETAILED DESCRIPTION OF THE EMBODIMENTS

Exemplary embodiments of the invention will be described in detail below with reference to the drawings. It should be noted that the relative arrangement of the components, the numerical expressions, and numerical values set forth in these embodiments do not limit the scope of the present invention unless it is specifically stated otherwise.

First Embodiment

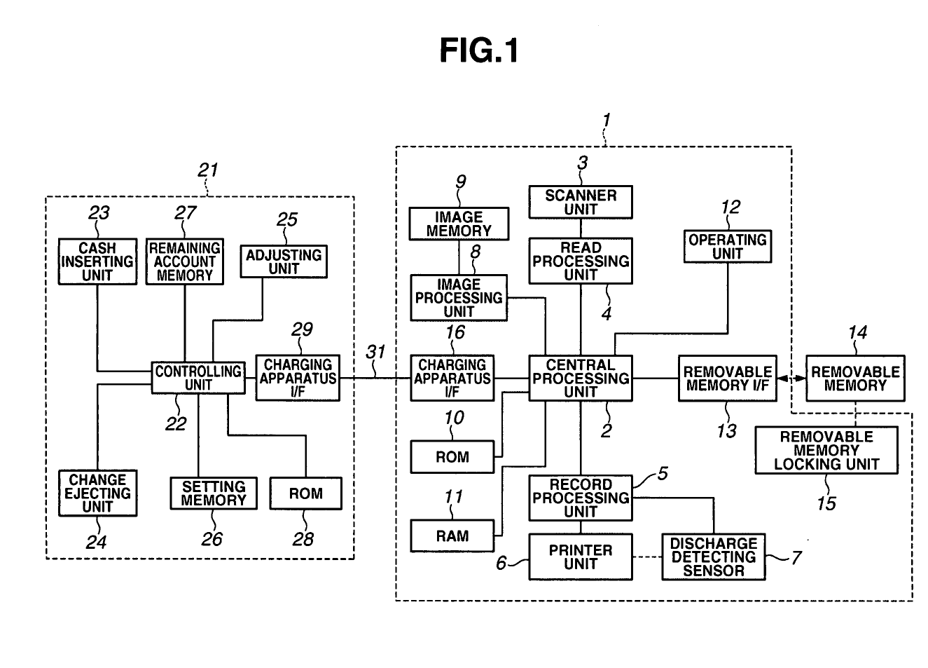

FIG. 1 is a block diagram showing an example of an image processing apparatus according to a first embodiment of the present invention. The image processing apparatus can be, for example, an MFP equipped with a charging function.

In FIG. 1, an MFP unit 1 can perform a scanner processing function, a print processing function, and a copy processing function by controlling a scanner unit 3 and a printer unit 6. A charging apparatus 21 can communicate with the MFP unit 1 via a predetermined interface.

The printer unit 6 is equipped with a color laser beam printer engine that can execute so-called electrophotographic processes. The scanner unit 3 is equipped with a CCD (charge-coupled device) image sensor (not shown) and reads document images fed from a document feeding apparatus such as an ADF (automatic document feeder).

First, each part of the MFP unit 1 shown in FIG. 1 will be described.

In the MFP unit 1, a central processing unit 2 generally controls each part of the MFP unit 1. The scanner unit 3 is configured to read documents which are set thereon.

A read processing unit 4 processes scanning and read signals when the scanner unit 3 is used for reading. A record processing unit 5 controls printing of images in the printer unit 6 and also processes recording image signals.

The printer unit 6 is used for printing on a recording paper sheet. In the apparatus according to this embodiment, the printer unit 6 is equipped with a discharge detecting sensor 7. When a printed recording paper sheet is output to a discharge tray, the discharge detecting sensor 7 detects ejection of the recording paper sheet and notifies the record processing unit 5 of that ejection.

An image processing unit 8 performs various processing for a variety of image signals handled by the MFP unit 1 to improve image quality. Image memory 9 functions as work memory for writing and reading images when the image processing unit 8 performs image processing.

Programs to be used by the central processing unit 2 for performing various processing and control are stored in a ROM 10. Another configuration may also be adopted in which an external memory device (not shown) is provided, and a control program is loaded into a RAM 11 from the external memory device. The RAM 11 is used to write and read data when the central processing unit 2 performs processing or control.

An operating unit 12 is operable by an operator to perform various operations. In this embodiment, the operating unit 12 is equipped with input keys for operations and a display panel. A removable memory interface (removable memory I/F) 13 is configured to connect removable memory 14 thereto. In this embodiment, the removable memory interface 14 includes a USB interface.

The removable memory 14 can be connected to the MFP unit 1 to enable an operator to bring image data therein or store image data.

In this embodiment, a removable memory locking unit 15 is provided to prevent the removable memory 14 from being removed while the removable memory 14 is being accessed. When the MFP unit 1 performs an operation to use the removable memory 14, the removable memory 14 is mechanically held and locked to prohibit removal of the removable memory 14, so that the removable memory 14 cannot be removed until the operation is completed.

A charging apparatus interface 16 interfaces the MFP 1 with the charging apparatus 21.

Next, each part of the charging apparatus 21 will be described.

In the charging apparatus 21 shown in FIG. 1, a control unit 22 generally controls each part of the charging apparatus 21. A cash inserting unit 23 is used for an operator to insert a charge (including bills and coins) therein for using the MFP unit 1. A change ejecting unit 24 is configured to eject change after the operator receives a copy, print, or scan service from the MFP unit 1 and is charged.

An adjusting unit 25 is configured to adjust the charge when the operator finishes with a copy, print, or scan service. A setting memory 26 updatably stores values set as the copy, print, and scan charges (charge per page) for charging. A remaining account memory 27 recognizes a remaining account determined by subtracting the charge set in the setting memory 26 from an amount of cash inserted into the cash inserting unit 23 each time the copy, print, or scan service is received.

A ROM 28 stores programs for use by the controlling unit 22 for performing processing and control of each part. A charging apparatus interface 29 interfaces the charging apparatus 21 with the MFP unit 1.

Next, an outline of the operation of the charging apparatus 21 shown in FIG. 1 will be described.

When recognizing inserting of cash into the cash inserting unit 23, the controlling unit 22 calculates the amount of inserted cash and writes it into the remaining account memory 27.

Then, after the copy, print, or scan service is provided by the MFP unit 1, the controlling unit 22 recognizes this via the charging apparatus interface 29 and subtracts the copy, print, or scan charge (charge per page) stored in the setting memory 26 from the amount stored in the remaining account memory 27.

If the amount stored in the remaining account memory 27 decreases and falls below any of the copy, print, or scan service charge (charge per page), the controlling unit 22 notifies the MFP unit 1 of unavailability of the pertinent service via the charging apparatus interface 29.

If an adjusting operation is performed via the adjusting unit 25, the controlling unit 22 notifies the MFP unit 1 of unavailability of all services of copying, printing, and scanning via the charging apparatus interface 29. At the same time, the controlling unit 22 recognizes the balance stored in the remaining account memory 27 and supplies change to the change ejecting unit 24.

Next, an interface signal 31 between the MFP unit 1 and the charging apparatus 21 will be described.

The interface signal 31 shown in FIG. 1 is exchanged between the MFP unit 1 and the charging apparatus 21 via the charging apparatus interface 16 and the charging apparatus interface 29.

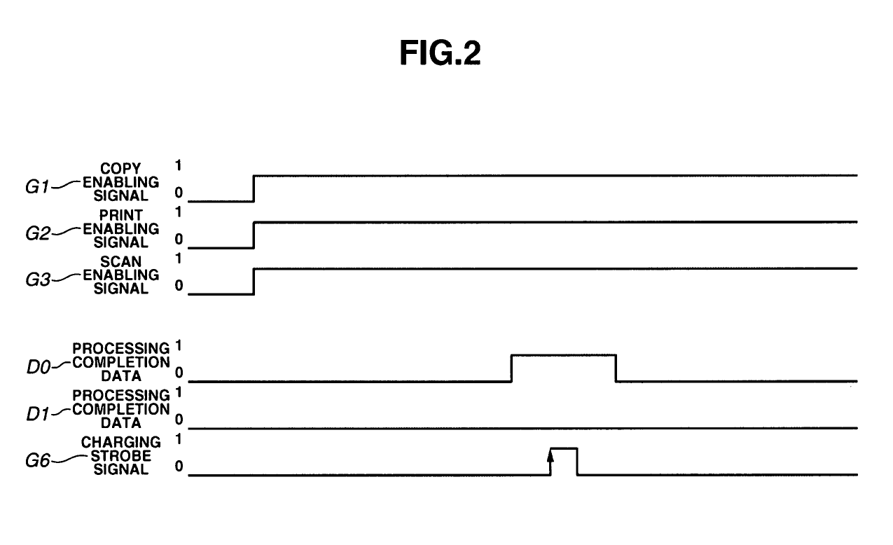

FIG. 2 is a timing chart illustrating the configuration and operation of the interface signal 31 shown in FIG. 1.

In FIG. 2, reference symbol G1 denotes a copy enabling signal. If, after cash is inserted into the cash inserting unit 23, the amount stored in the remaining account memory 27 is greater than or equal to the charge per page of copying stored in the setting memory 26, assuming that the copy service maybe provided, the copy enabling signal G1 is set to “1” in the charging apparatus interface 29.

If no cash is inserted into the cash inserting unit 23, or the amount stored in the remaining account memory 27 is less than the charge per page of copying stored in the setting memory 26, or an adjusting operation is requested via the adjusting unit 25, the copy enabling signal G1 is set to “0”.

Reference symbol G2 denotes a print enabling signal. If, after cash is inserted into the cash inserting unit 23, the amount stored in the remaining account memory 27 is greater than or equal to the charge per page of printing stored in the setting memory 26, assuming that the print service may be provided, the print enabling signal G2 is set to “1” in the charging apparatus interface 29. If no cash is inserted into the cash inserting unit 23, or the amount stored in the remaining account memory 27 is less than the charge per page of printing stored in the setting memory 26, or an adjusting operation is requested via the adjusting unit 25, the print enabling signal G2 is set to “0”.

Reference symbol G3 denotes a scan enabling signal. If, after cash is inserted into the cash inserting unit 23, the amount stored in the remaining account memory 27 is greater than or equal to the charge per page of scanning stored in the setting memory 26, assuming that the scanning service may be provided, the scan enabling signal G3 is set to “1” in the charging apparatus interface 29.

If no cash is inserted into the cash inserting unit 23, or the amount stored in the remaining account memory 27 is less than the charge per page of scanning stored in the setting memory 26, or an adjusting operation is requested via the adjusting unit 25, the scan enabling signal G3 is set to “0”.

The MFP unit 1 performs a copy, print, or scan operation, and when any operation is completed, the MFP unit 1 sends data on processing to the charging apparatus 21.

That is, when a copy, print, or scan operation is completed, the central processing unit 2 outputs processing completion data D0 and processing completion data D1 shown in FIG. 2 via the charging apparatus interface 16 to indicate the type of the completed service operation.

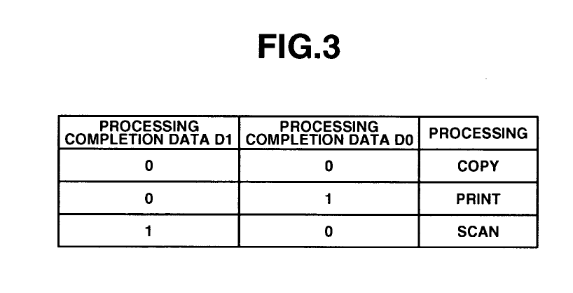

The type of operation indicated by the processing completion data D0 and processing completion data D1 is defined in the table shown in FIG. 3 depending on the combination of “1” and “0” signals of the processing completion data D0 and processing completion data D1.

During outputting of the processing completion data D0 and processing completion data D1, the charging apparatus interface 16 on the MFP unit 1 side sends a charging strobe signal G6 so that the data is captured by the charging apparatus interface 29 on the charging apparatus 21 side.

The charging apparatus 21 detects the processing completion data D0 and processing completion data D1 via the charging apparatus interface 29 and captures the processing completion data D0 and processing completion data D1 upon detection of a rising edge of the charging strobe signal G6. At the same time, assuming that the copy, print, or scan operation has successfully been completed, the charging apparatus 21 performs charging processing.

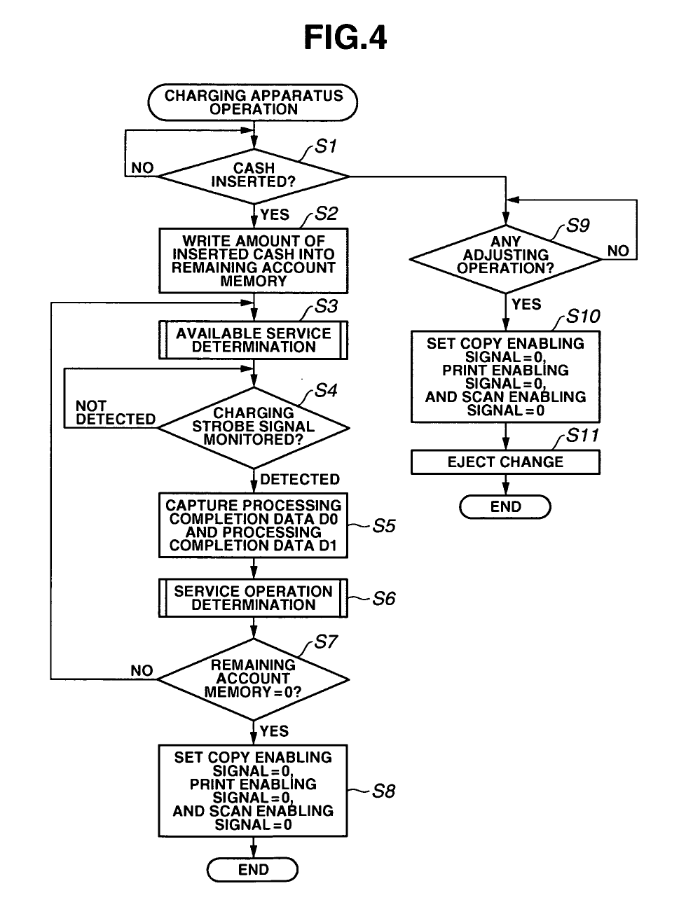

First, detailed operations of the charging apparatus 21 will be described with reference to the flowcharts shown in FIGS. 4, 5, and 6.

FIG. 4 is a flowchart showing an example of the first data processing procedure in the image processing apparatus of this embodiment and corresponds to a charging processing procedure to be executed by the controlling unit 22 in the charging apparatus 21. Each step is implemented by execution of a control program stored in the ROM 28 after loading it into work memory by the controlling unit 22.

First, the controlling unit 22 monitors inserting of cash into the cash inserting unit 23 (step S1). When an operator inserts cash to receive the copy, print, or scan service, the controlling unit 22 recognizes that cash has been inserted into the cash inserting unit 23. This prompts the controlling unit 22 to calculate the amount of inserted cash and write the amount into the remaining account memory 27 (step S2).

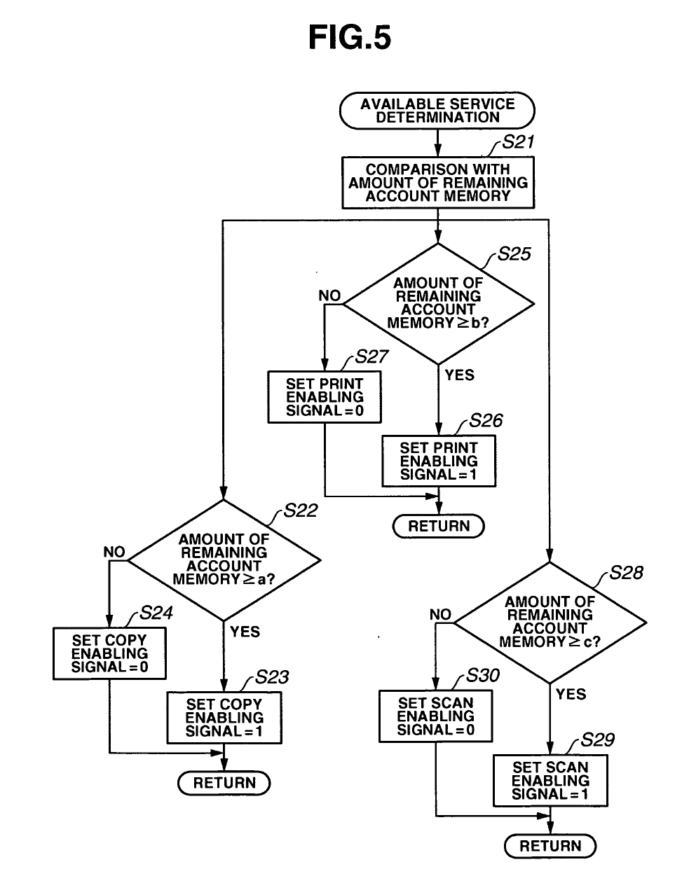

Next, the controlling unit 22 executes a determination routine shown in FIG. 5 to determine available service operations based on the amount stored in the remaining account memory 27 (step S3).

FIG. 5 is a flowchart showing an example of the second data processing procedure in the image processing apparatus of this embodiment and corresponds to a charging processing procedure to be executed by the controlling unit 22 in the charging apparatus 21. Each step is implemented by execution of a control program stored in the ROM 28 after loading it into work memory by the controlling unit 22.

First, the controlling unit 22 makes a comparison with the amount stored in the remaining account memory 27 (step S21). The controlling unit 22 compares the amount stored in the remaining account memory 27 and the copy charge (charge per page of copying: “a”) stored in the setting memory 26 to determine whether the amount stored in the remaining account memory 27 is greater than or equal to “a” (step S22). If the controlling unit 22 determines that the amount stored in the remaining account memory 27 is greater than or equal to “a”, assuming that the copy service may be provided, the copy enabling signal G1 is set to “1” (step S23). Then, processing returns to proceed to step S4 shown in FIG. 4.

If the controlling unit 22 determines that the amount stored in the remaining account memory 27 is less than “a” in step S22, assuming that the copy service cannot be provided, the copy enabling signal G1 is set to “0” (step S24). Then, processing returns to proceed to step S4 shown in FIG. 4.

Similarly, the controlling unit 22 compares the amount stored in the remaining account memory 27 and the print charge (charge per page of printing: “b”) stored in the setting memory 26 to determine whether the amount stored the remaining account memory 27 is greater than or equal to “b” (step S25). If the controlling unit 22 determines that the amount stored in the remaining account memory 27 is greater than or equal to “b”, assuming that the print service may be provided, the print enabling signal G2 is set to “1” (step S26). Then, processing returns to proceed to step S4 shown in FIG. 4.

If the controlling unit 22 determines that the amount stored in the remaining account memory 27 is less than “b” in step S25, assuming that the print service cannot be provided, the print enabling signal G2 is set to “0” (step S27). Then, processing returns to proceed to step S4 shown in FIG. 4.

Similarly, the controlling unit 22 compares the amount stored in the remaining account memory 27 and the scan charge (charge per page of scanning: “c”) stored in the setting memory 26 to determine whether the amount stored in the remaining account memory 27 is greater than or equal to “c” (step S28). If the controlling unit 22 determines that the amount stored in the remaining account memory 27 is greater than or equal to “c”, assuming that the scan service may be provided, the scan enabling signal G3 is set to “1” (step S29). Then, processing returns to proceed to step S4 shown in FIG. 4.

If the controlling unit 22 determines that the amount stored in the remaining account memory 27 is less than “c” in step S28, assuming that the scan service cannot be provided, the scan enabling signal G3 is set to “0” (step S30). Then, processing returns to proceed to step S4 shown in FIG. 4.

Then, the controlling unit 22 monitors the service operation performed in the MFP unit 1.

That is, the controlling unit 22 monitors the charging strobe signal G6 in the charging apparatus interface 29 (step S4). If the charging strobe signal G6 is detected in the charging apparatus interface 29, the controlling unit 22 captures processing completion data D0 and processing completion data D1 upon detection of a rising edge of the charging strobe signal G6 (step S5).

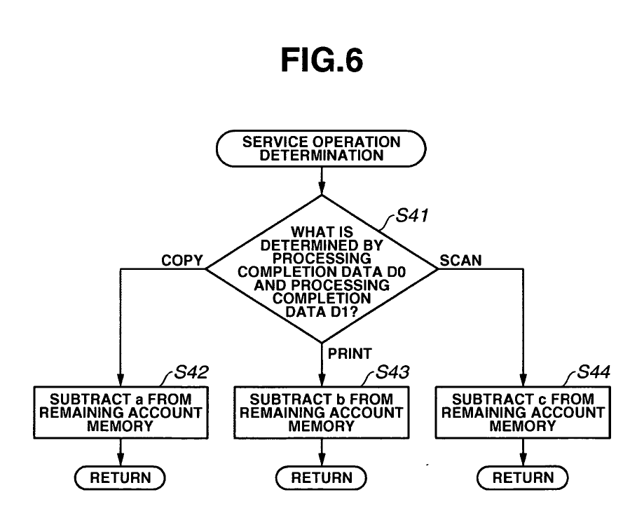

The controlling unit 22 executes a service operation determination routine shown in FIG. 6 to determine the processing based on the processing completion data D0 and processing completion data D1 before performing charge subtractions (step S6).

FIG. 6 is a flowchart showing an example of the third data processing procedure in the image processing apparatus of this embodiment and corresponds to a charging processing procedure to be executed by the controlling unit 22 in the charging apparatus 21. Each step is implemented by execution of a control program stored in the ROM 28 after loading it into work memory by the controlling unit 22.

First, the controlling unit 22 compares a combination of the processing completion data D0 and processing completion data D1 with the table shown in FIG. 3 to determine the service (copy, print, scan) provided (step S41). Accordingly, the controlling unit 22 subtracts the charge for the service provided from the balance.

That is, the controlling unit 22 reads the amount stored in the remaining account memory 27 and if the service provided is copying, with reference to the setting memory 26, “a” is subtracted from the amount stored in the remaining account memory 27 (step S42). Then, processing returns to proceed to step S7 shown in FIG. 4.

If the service provided is determined to be printing, “b” is subtracted from the amount stored in the remaining account memory 27 (step S43). Then, processing returns to proceed to step S7 shown in FIG. 4.

If the service provided is determined to be scanning, “c” is subtracted from the amount stored in the remaining account memory 27 (step S44). Then, processing returns to proceed to step S7 shown in FIG. 4.

Then, the controlling unit 22 reads the value stored in the remaining account memory 27 to determine whether the value is equal to “0” (step S7). If the value is determined not to be equal to “0” (remaining account>0), a similar processing operation from step S3 is repeated.

If the value stored in the remaining account memory 27 is equal to “0” in step S7 (no remaining account), the controlling unit 22 sets all of the copy enabling signal G1, print enabling signal G12, and scan enabling signal G3 to “0” (step S8) and terminates this processing.

After confirming that cash has been inserted into the cash inserting unit 23, the controlling unit 22 always monitors any adjusting operations via the adjusting unit 25 by an operator (step S9). That is, if an adjusting operation performed via the adjusting unit 25 is detected, the controlling unit 22 immediately sets all of the copy enabling signal G1, print enabling signal G12, and scan enabling signal G3 to “0” to indicate unavailability of all services (step S10). At the same time, the controlling unit 22 reads the amount stored in the remaining account memory 27 to eject the amount to the change ejecting unit 24 as change (step S11) and terminates this processing.

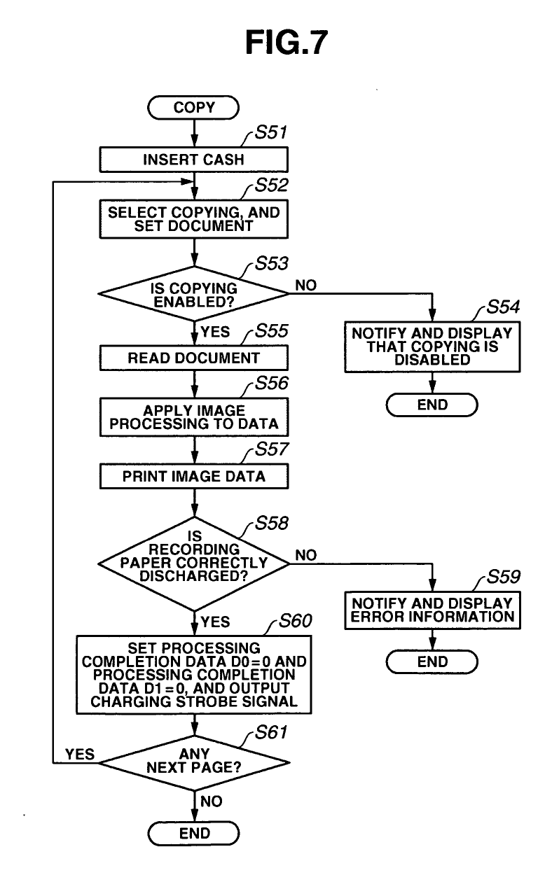

Next, detailed operations when an operator performs a copy operation using the MFP unit 1 will be described with reference to the flowchart in FIG. 7.

FIG. 7 is a flowchart showing an example of the fourth data processing procedure in the image processing apparatus of this embodiment and corresponds to the copy processing procedure to be executed by the central processing unit 2 in the MFP unit 1. Each step is implemented by execution of a control program stored in the ROM 10 after loading it into work memory by the central processing unit 2.

First, the operator inserts cash into the cash inserting unit 23 of the charging apparatus 21 connected to the MFP unit 1 (step S51).

Then, the operator performs an operation to select the copy service on a screen (not shown) used for selecting functions, etc., in the operating unit 12 and sets a document to the scanner unit 3 (step S52). If a document feeding apparatus such as an ADF is connected, a batch of documents is assumed to be set to the document feeding apparatus.

Next, the central processing unit 2 determines whether the copy enabling signal G1 is “1” via the charging apparatus interface 16 (step S53). If the central processing unit 2 determines that the copy enabling signal G1 is “0”, assuming that the copy service cannot be provided, the central processing unit 2 instructs the operating unit 12 to display unavailability of the copy service (step S54) and terminates this processing.

If the central processing unit 2 determines that the copy enabling signal G1 is “1” in step S53, assuming that the copy service may be provided, the copy operation is performed. That is, the central processing unit 2 performs read processing of a document in the scanner unit 3 under the control of the read processing unit 4 (step S55).

Then, the central processing unit 2 transfers the read image data obtained by the read processing to the image processing unit 8. The image processing unit 8 applies image processing to the data using the image memory 9 (step S56).

Furthermore, the central processing unit 2 transfers the processed image data to the record processing unit 5. The record processing unit 5 generates record image data from the transferred image data and prints image data on a recording paper sheet while controlling the printer unit 6 (step S57).

At this point, the central processing unit 2 detects whether a recording paper sheet with a correct print record has been discharged from the printer unit 6 using the discharge detecting sensor 7 and determines whether the recording paper sheet has been discharged based on the status thereof (step S58). If the central processing unit 2 determines that the discharge detecting sensor 7 has detected that the recording paper has not been discharged correctly, assuming that recording paper jam has occurred, the central processing unit 2 instructs the operating unit 12 to display error information (step S59) and terminates the copy service.

If the central processing unit 2 detects that the recording paper sheet has been discharged correctly using the discharge detecting sensor 7 in step S58, assuming that a copy has been made successfully, the central processing unit 2 sends charging information. That is, the central processing unit 2 sets the processing completion data D0 to “0” and the processing completion data D1 to “0” via the charging apparatus interface 16 and then sends the charging strobe signal G6 (step S60).

What has been described is an operation for making a copy of one page, which is completed if only a copy of one page should be made.

Then, whether to make copies of multiple pages is determined (step S61). If it is determined that there is the next page, the operation from step S52 is repeated.

If it is determined that there is no more pages to be copied in step S61, this process terminates.

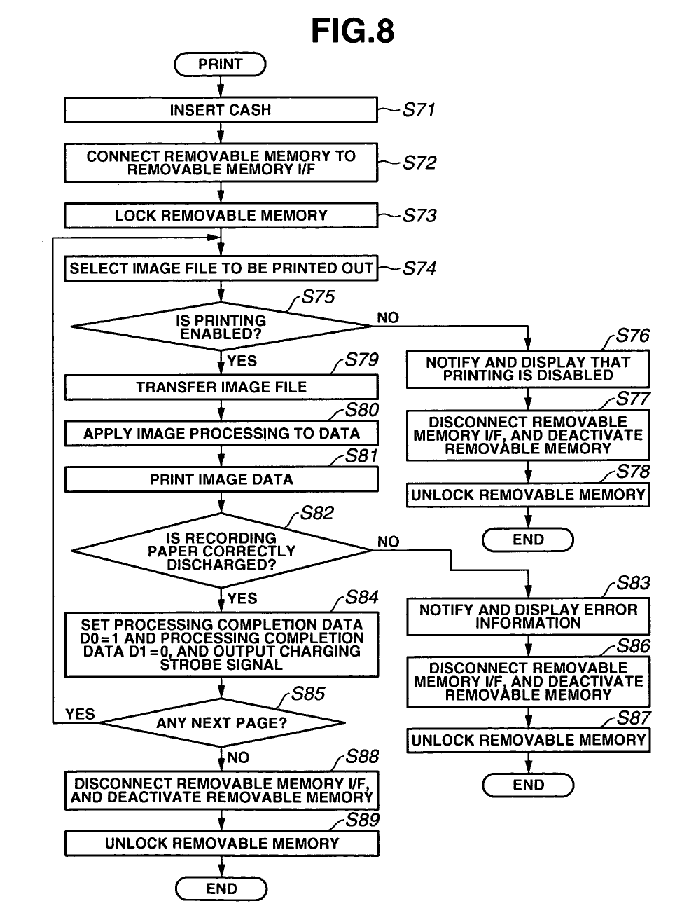

Next, detailed operations when an operator performs a print operation of image data in removable memory using the MFP unit 1 will be described with reference to the flowchart in FIG. 8.

FIG. 8 is a flowchart showing an example of the fifth data processing procedure in the image processing apparatus of this embodiment and corresponds to the print processing procedure to be executed by the central processing unit 2 in the MFP unit 1. Each step is implemented by execution of a control program stored in the ROM 10 after loading it into work memory by the central processing unit 2.

First, the operator inserts cash into the cash inserting unit 23 (step S71). Then, the operator connects the removable memory 14 to the removable memory interface 13 (step S72).

If, at this point, connection of the removable memory 14 is detected via the removable memory interface 13, the central processing unit 2 mechanically locks the removable memory 14 using the removable memory locking unit 15 to make the removable memory 14 unremovable (The removable memory 14 is fixed so that it cannot be removed) so that the operator cannot remove the removable memory 14 (step S73).

Any mechanical locking method may be used, for example, a method of electrically making a cover member inoperable using a latch can be considered. The form and lock method may be determined appropriately depending on the type of removable memory.

Then, the operator performs an operation to select the print service via an operation screen displayed in the operating unit 12. At the same time, the operator selects the desired image file to be printed from among image files stored in the removable memory 14 via the operating unit 12 (step S74).

At this point, it becomes possible, by displaying the fact that the removable memory 14 is locked so that it cannot be removed, to call the operator's attention or for the operator to make sure thereof.

Next, the central processing unit 2 determines whether the print enabling signal G2 is “1” via the charging apparatus interface 16 (step S75). If the central processing unit 2 determines that the print enabling signal G2 is “0”, assuming that the print service cannot be provided, the central processing unit 2 instructs the operating unit 12 to display unavailability of the print service (step S76).

The central processing unit 2 immediately terminates writing data to the removable memory 14 and reading data from the removable memory 14 via the removable memory interface 13 and disconnects the removable memory interface 13 to deactivate the removable memory 14 (step S77).

Next, the central processing unit 2 unlocks the removable memory 14 locked by the removable memory locking unit 15 (step S78) and terminates this processing.

If the central processing unit 2 determines that the print enabling signal G2 is “1” in step S75, assuming that the print service may be provided, the print operation is performed. That is, the central processing unit 2 reads an image file selected by the operator in the operating unit 12 from the removable memory 14 via the removable memory interface 13 and transfers the image file data to the image processing unit 8 (step S79).

When an image file is selected, whether to display printable variations in detail in the operating unit 12 such as printing the whole file or part thereof, or in layout printing is optional. Alternatively, a configuration can be considered in which multiple image files are selected and each of pages extracted from the selected image files is sorted before printing them as an image file.

Next, the image processing unit 8 applies predetermined image processing to the data using the image memory 9 (step S80). Furthermore, the central processing unit 2 transfers the processed image data to the record processing unit 5. The record processing unit 5 creates record image data from the transferred image data and prints image data on a recording paper sheet while controlling the printer unit 6 (step S81).

At this point, the central processing unit 2 determines whether the recording paper sheet with a correct print record has been discharged from the printer unit 6 based on the detection status of the discharge detecting sensor 7 (step S82). If the central processing unit 2 determines that the recording paper sheet has not been discharged correctly using the discharge detecting sensor 7, assuming that recording paper jam has occurred, the central processing unit 2 instructs the operating unit 12 to display error information (step S83). Also, the central processing unit 2 immediately terminates writing data to the removable memory 14 and reading data from the removable memory 14 via the removable memory interface 13 and disconnects the removable memory interface 13 to deactivate the removable memory 14 (step S86).

Furthermore, the central processing unit 2 unlocks the removable memory 14 locked by the removable memory locking unit 15 (step S87) and terminates this print processing.

After error notification in step S83, the operator may stop the print operation by issuing a print stop instruction via the operating unit 12 before proceeding to steps S86 and S87.

If, in step S82, the central processor 2 determines that the discharge detecting sensor 7 has detected that the recording paper sheet has been discharged correctly, assuming that a copy has been made successfully, the central processing unit 2 sends charging information. That is, the central processing unit 2 sets the processing completion data D0 to “1” and the processing completion data D1 to “0” via the charging apparatus interface 16 and then sends the charging strobe signal G6 (step S84). What has been described is an operation for making a print of one page.

Then, whether a setting is made to make prints of multiple pages is determined (step S85). Then, if it is determined that there is the next page, a similar processing after returning to step S74 is repeated.

If it is determined that there is no page to be printed in step S85, the print processing is terminated. At this point, the central processing unit 2 immediately terminates writing data to the removable memory 14 and reading data from the removable memory 14 via the removable memory interface 13 and disconnects the removable memory interface 13 to deactivate the removable memory 14 (step S88).

Furthermore, the central processing unit 2 unlocks the removable memory 14 locked by the removable memory locking unit 15 (step S89) and terminates this print processing.

The reason for locking the removable memory 14 shown in FIG. 1 using the removable memory locking unit 15 in the above print operation is to prevent the operator from inadvertently removing the removable memory 14 before a normal print operation is completed.

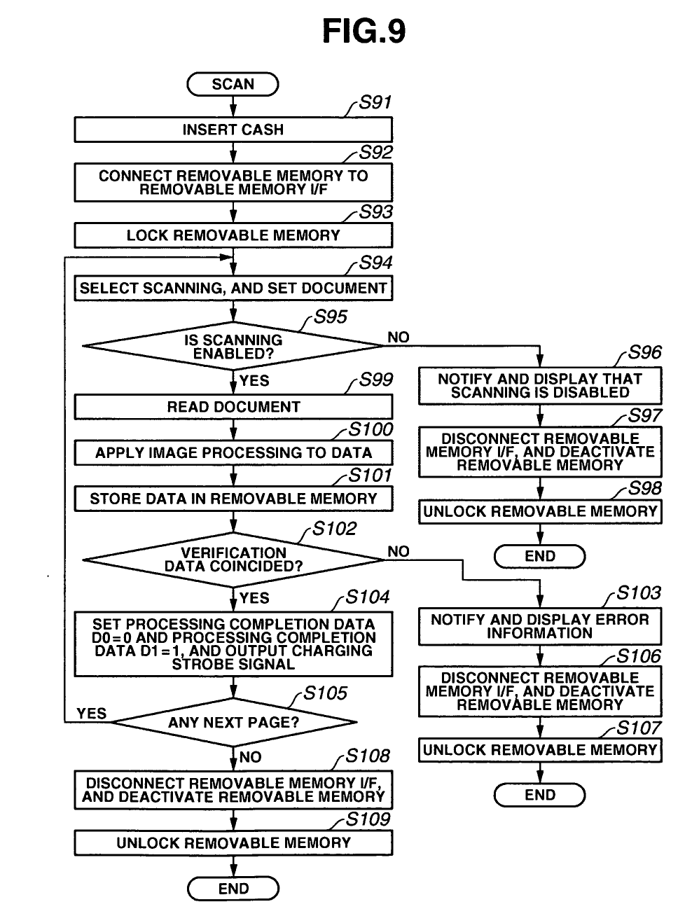

Next, detailed operations when an operator scans a document and stores image data in removable memory using the MFP unit 1 will be described with reference to the flowchart in FIG. 9.

FIG. 9 is a flowchart showing an example of the sixth data processing procedure in the image processing apparatus of this embodiment and corresponds to the scan processing procedure to be executed by the central processing unit 2 in the MFP unit 1. Each step is implemented by execution of a control program stored in the ROM 10 after loading it into work memory by the central processing unit 2.

First, the operator inserts cash into the cash inserting unit 23 (step S91). Then, the operator connects the removable memory 14 to the removable memory interface 13 (step S92). If, at this point, connection of the removable memory 14 is detected via the removable memory interface 13, the central processing unit 2 locks the removable memory 14 using the removable memory locking unit 15 so that the operator cannot remove the removable memory 14 (step S93).

Then, the operator performs an operation to select the scan service and sets a document to the scanner unit 3 (step S94).

Next, the central processing unit 2 determines the scan enabling signal G3 via the charging apparatus interface 16 (step S95).

If the scan enabling signal G3 in FIG. 2 is “0”, assuming that the scan service cannot be provided, the central processing unit 2 instructs the operating unit 12 to display unavailability of the scan service (step S96). At the same time, the central processing unit 2 immediately terminates writing data to the removable memory 14 and reading data from the removable memory 14 via the removable memory interface 13 and disconnects the removable memory interface 13 to deactivate the removable memory 14 (step S97).

Furthermore, the central processing unit 2 unlocks the removable memory 14 locked by the removable memory locking unit 15 (step S98) and terminates this processing.

If the central processing unit 2 determines that the scan enabling signal G3 is “1” in step S95, assuming that the scan service can be provided, the scan service is performed. That is, the central processing unit 2 performs read processing of a document in the scanner unit 3 under the control of the read processing unit 4 (step S99).

Then, the central processing unit 2 transfers the read image data obtained by the read processing to the image processing unit 8. The image processing unit 8 applies image processing to the data using the image memory 9 (step S100).

The central processing unit 2 stores the processed image data as an image file with an arbitrary file name in the removable memory 14 via the removable memory interface 13 (step S101).

Then, the central processing unit 2 reads the above image data file written into the removable memory 14 via the removable memory interface 13 to conduct a verification test against the image data temporarily stored in the image memory 9 in step S100 to be written into the removable memory 14 (step S102).

If the verification test produces a mismatching result, assuming that the image file data has not been written into the removable memory 14 correctly, the central processing unit 2 instructs the operating unit 12 to display error information (step S103) and terminates the scan operation.

At the same time, the central processing unit 2 immediately terminates writing data to the removable memory 14 and reading data from the removable memory 14 via the removable memory interface 13 and disconnects the removable memory interface 13 to deactivate the removable memory 14 (step S106).

Furthermore, the central processing unit 2 unlocks the removable memory 14 locked by the removable memory locking unit 15 (step S107) and terminates the processing.

After the error notification in step S103, the operator may stop the print operation by issuing a print stop instruction via the operating unit 12 before proceeding to steps S106 and S107.

If the central processing unit 2 determines that a matching result has been produced in step S102, assuming that the scan operation has been performed correctly, the central processing unit 2 sends charging information.

That is, the central processing unit 2 sets the processing completion data D0 to “0” and the processing completion data D1 to “1” via the charging apparatus interface 16 and then sends the charging strobe signal G6 (step S104).

What has been described is an operation for making a scan of one page. If multiple pages should be scanned, whether there is the next page to be scanned is determined (step S105). If it is determined that there is the next page, the operation from step S94 is repeated.

If it is determined that there is no page to be scanned in step S105, the central processing unit 2 immediately terminates writing data to the removable memory 14 and reading data from the removable memory 14 via the removable memory interface 13 and disconnects the removable memory interface 13 to deactivate the removable memory 14 (step S108).

Furthermore, the central processing unit 2 unlocks the removable memory 14 locked by the removable memory locking unit 15 (step S109) and terminates this processing.

The reason for locking the removable memory 14 using the removable memory locking unit 15 in the above scan operation shown in FIG. 9 is to prevent the operator from inadvertently removing the removable memory 14 before a normal scan operation is completed and also to prevent the operator from taking out data without charging by removing the removable memory 14 before a charging operation starts.

According to the above embodiment, if, in an MFP apparatus equipped with a charging function for providing a print or scan service by connecting removable memory, the amount of inserted cash decreases to 0 by charge collection, or the remaining account falls below the charge required for the print or scan service, or an operator performs an adjusting operation, the MFP apparatus detects the above situations, terminates reading from the removable memory and writing to the removable memory, and disconnects the removable memory interface to deactivate the removable memory.

Therefore, the operator can always remove the removable memory safely after an operation without being aware of the procedure for removing the removable memory, thus preventing damage of data in the removable memory and memory destruction and increasing user convenience.

Second Embodiment

In the above first embodiment, an example of a system in which a user directly inserts cash into the cash inserting unit 23 for charging processing is adopted. The present invention can also be applied in the same way by replacing the system with processing of authentication by a server of an external credit company equipped with a card reading apparatus to enable credit card adjusting and processing to determine whether a credit card adjusting has been performed in charging processing.

Third Embodiment

In the above first embodiment, an example of a system in which a user directly inserts cash into the cash inserting unit 23 for charging processing is adopted. The present invention can also be applied in the same way by equipping an interface that can communicate with cellular phones, using electronic cash pooled for each cellular phone, and replacing the system with charging processing of the electronic cash.

Fourth Embodiment

In the above first embodiment, examples of locking and unlocking the removable memory 14 in scan processing and print processing have been described. In copy processing, if, for example, read document images and image data (for example, form data and image data taken by a user) stored in the removable memory 14 should be combined before outputting to the printer unit 6, a configuration may be adopted in which locking and unlocking of the removable memory 14 in print processing shown in FIG. 8 and copy processing shown in FIG. 7 are combined.

Fifth Embodiment

In the above first embodiment, examples of performing image processing using the single removable memory 14 have been described. If multiple pieces of removable memory 14 are used for performing image processing, a configuration may be adopted in which a user is enabled to safely carry out a removable memory replacement request by determining the detachable timing.

Sixth Embodiment

In the above first embodiment, examples of image processing using the removable memory 14 have been described. User benefits may be provided by determining whether image data to be registered for scan processing, etc., can be registered by examining free space in the removable memory 14. Based on the capacity thereof, a replacement request of the removable memory, addition of image processing such as thinning-out or compression processing of the size of image data to be stored, or deletion of image data registered in the removable memory 14 can be performed.

Seventh Embodiment

In the above first embodiment, examples of an MFP executing the print function, scan function, and copy function have been described. If processing for sending and receiving image data by accessing a public line is performed, for example, if processing for sending and receiving facsimile data is performed, a configuration may be adopted in which image data to be sent is read after determining whether the removable memory 14 is mounted or the removable memory 14 shown in FIG. 9 can be locked and unlocked when storing received image data.

Eighth Embodiment

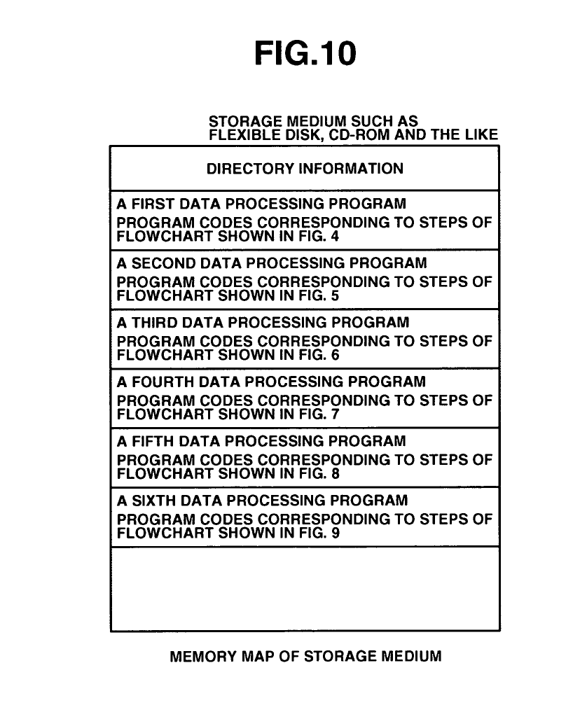

The configuration of a data processing program that can be read by an image processing apparatus of embodiments of the present invention will be described below with reference to the memory map shown in FIG. 10.

FIG. 10 is a diagram illustrating a memory map of storage medium in which various data processing programs that can be read by an image processing apparatus of embodiments of the present invention are stored.

Though not shown, information for managing programs stored in storage medium such as version information and author names is also stored and, in some cases, information dependent on the program reading side operating system, etc., such as icons is also stored.

Moreover, data subordinate to various programs is also managed in the storage medium. In some cases, a program used for installing programs on a computer and, if programs are compressed, a program for decompressing such programs is also stored.

Functions shown in FIGS. 4 to 9 in this embodiment may be executed by programs installed on a host computer from outside. In such cases, the present invention will also be applied even if information including programs is supplied to an output apparatus from storage media, such as a CD-ROM, flash memory, and an FD or from an external storage medium via a network.

As has been described above, the present invention will also be achieved by supplying a storage medium in which program code to implement the functions of the above embodiments is recorded to a system or an apparatus and allowing a computer (or CPU or MPU) of the system or apparatus to read the program code stored in the storage medium and execute it.

In such cases, the program code itself read from a storage medium will implement new functions of the present invention and thus, a storage medium in which the program code is stored will constitute the present invention.

Therefore, as long as a function of a program is provided, the form of a program makes no difference whether it is object code, a program executed by an interpreter, or script data to be supplied to the operating system.

As a storage medium for supplying programs, for example, a flexible disk, a hard disk, an optical disk, a magneto-optical disk, MO, CD-ROM, CD-R, CD-RW, a magnetic tape, a nonvolatile memory card, ROM, and DVD can be used.

In such cases, program code itself read from a storage medium will implement the functions of the above embodiments and the storage medium in which the program code is stored will constitute the present invention.

Another method of supplying a program is to connect to a home page of the Internet using a browser of a client computer and to download a computer program itself or a compressed file containing an auto-installation function of the present invention from the home page to a storage medium such as a hard disk. The download can also be implemented by dividing program code constituting a program of the present invention into multiple files and downloading each file from different homes pages. That is, WWW servers and ftp servers allowing multiple users to download program files for implementing functional processing of the present invention on a computer will also be included in claims of the present invention.

The present invention can also be implemented by distributing a program of the present invention after encoding the program and storing it in a storage medium such as CD-ROM, allowing only users who meet the predetermined conditions to download key information for decoding the encoded program from a home page via the Internet, and installing the program by executing the encoded program using the key information.

Also, a case in which, in addition to implementation of the functions of the above embodiments by executing program code read by a computer, based on instructions of the program code, the operating system, etc., running on a computer performs part or all of actual processing, and with the processing, the functions of the above embodiments are implemented is included.

Furthermore, a case in which program code read from a storage medium is written into memory contained in a function expansion board inserted into a computer or a function expansion unit connected to a computer and then, based on instructions of the program code, a CPU and so forth contained in the function expansion board or function expansion unit performs part or all of actual processing, and with the processing, the functions of the above embodiments are implemented is included.

According to the present invention, situations in which removable memory is detached in such improper timing as to cause problems for an image processing request via removable memory can be prevented or reduced. Also, an operator can safely remove removable memory after an operation without being aware of the procedure for removing the removable memory. Thus, damage of data in the removable memory and memory destruction can be prevented and, also, user convenience can be increased.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-170224 filed Jun. 10, 2005, which is hereby incorporated by reference herein in its entirety.

What is claimed is:

1. An image processing apparatus, comprising:
an interface unit adapted to connect removable memory thereto;
an image processing execution unit adapted to execute image processing via the removable memory;
a charging unit adapted to perform charge collection processing for execution of the image processing;
a determination unit adapted to determine whether charge collection processing by the charging unit is possible or not; and
a control unit adapted to, responsive to the determination unit determining that the charge collection processing is possible and when execution of the image processing for which collection processing can be performed by the charging unit is completed, cause the charging unit to perform collection processing for execution of the image processing and cause the interface unit to shift to a disconnected state so as to make the removable memory removable.

2. The image processing apparatus according to claim 1, wherein the control unit is adapted to cause the removable memory to shift to an inactive state by causing the interface unit to shift to a disconnected state.

3. The image processing apparatus according to claim 2, further comprising a lock unit adapted to cause the removable memory to shift to one of a locked state and a unlocked state with respect to the interface unit,
wherein the lock unit causes the removable memory to shift from the locked state to the unlocked state after the control unit causes the removable memory to shift to the inactive state.

4. The image processing apparatus according to claim 1, wherein completion of execution of the image processing is a state in which execution of the image processing is not permitted.

5. The image processing apparatus according to claim 4, wherein the state in which execution of the image processing is not permitted includes one of a state in which a remaining account inserted in charging processing by the charging unit is less than an amount for execution of an image processing request and an adjusting instruction state.

6. The image processing apparatus according to claim 1, wherein completion of execution of the image processing is a state in which execution of the image processing of multiple pages is all completed.

7. The image processing apparatus according to claim 1, wherein completion of execution of the image processing is a state in which execution of the image processing results in error.

8. The image processing apparatus according to claim 7, wherein the control unit is adapted to disconnect the interface unit responsive to an abort instruction when execution of the image processing results in error.

9. The image processing apparatus according to claim 1, wherein the image processing includes scan storage processing in which document image data read by a scanner is stored in the removable memory, print processing in which image data read from the removable memory is printed by a printer, reception processing in which image data received from an external apparatus is stored in the removable memory, and transmission processing in which image data read from the removable memory is transmitted to an external apparatus.

10. The image processing apparatus according to claim 1, wherein the charging unit performs charge collection processing when normal ejection of a recording paper sheet is detected during execution of the image processing.

11. The image processing apparatus according to claim 1, wherein the charging unit performs charge collection processing when image data to be written during execution of the image processing and image data written into the removable memory are verified to match.

12. The image processing apparatus according to claim 1, wherein the interface unit includes a USB interface.

13. An image processing method for an image processing apparatus including an interface unit adapted to connect removable memory thereto, the image processing method comprising:
an image processing execution step of executing image processing via the removable memory;
a charging step of performing charge collection processing for execution of the image processing;
a determination step of determining whether charge collection processing in the charging step is possible or not; and
a controlling step of, when it is determined in the determination step that the charge collection processing is possible and execution of the image processing for which collection processing can be performed in the charging step is completed, performing the charging step of performing collection processing for execution of the image processing and causing the interface unit to shift to a disconnected state so as to make the removable memory removable.

14. A computer-readable medium having stored thereon a computer program comprising program code having computer-executable instructions for causing a computer to execute an image processing method according to claim 13.

15. An image processing apparatus, comprising:
an interface unit adapted to connect removable memory thereto;
an image processing execution unit adapted to execute image processing via the removable memory;
a charging unit adapted to perform charge collection processing for execution of the image processing;
a determination unit adapted to determine whether charge collection processing by the charging unit is possible or not; and
a control unit adapted to, responsive to the determination unit determining that the charge collection processing is not possible, cause the charging unit to perform collection processing for execution of the image processing and cause the interface unit to shift to a disconnected state so as to make the removable memory removable.

16. An image processing method for an image processing apparatus including an interface unit adapted to connect removable memory thereto, the image processing method comprising:
an image processing execution step of executing image processing via the removable memory;
a charging step of performing charge collection processing for execution of the image processing;
a determination step of determining whether charge collection processing in the charging step is possible or not; and
a control step of, when it is determined in the determination step that the charge collection processing is not possible, performing the charging step of performing collection processing for execution of the image processing and causing the interface unit to shift to a disconnected state so as to make the removable memory removable.

17. A computer-readable medium having stored thereon a computer program comprising program code having computer-executable instructions for causing a computer to execute an image processing method according to claim 16.
